(19) United States
(12) Patent Application Publication
(10) Pub. No.: US 2025/0217206 A1
(43) Pub. Date: Jul. 3, 2025

(54) COMPUTING TASK PROCESSING METHOD AND APPARATUS

(71) Applicant: Alipay (Hangzhou) Information Technology Co., Ltd., Hangzhou (CN)

(72) Inventors: Wei QIN, Hangzhou (CN); Xiabao WU, Hangzhou (CN); Yongchao LIU, Hangzhou (CN)

(21) Appl. No.: 18/936,771

(22) Filed: Nov. 4, 2024

(30) Foreign Application Priority Data
Dec. 27, 2023 (CN) 202311839576.2

(51) Int. Cl. G06F 9/52; G06N 3/08

(52) U.S. Cl. CPC G06F 9/52; G06N 3/08

(57) ABSTRACT

Implementations of the present specification provide a computing task processing method and apparatus. In the computing task processing method, a first computing task can be obtained, and the first computing task includes a first operator execution logic graph used for task computing; operator reconstruction is performed on the first operator execution logic graph based on an operator dependency in the first operator execution logic graph and a data cache capacity for operator computing, to obtain a second operator execution logic graph; and a second computing task including the second operator execution logic graph is provided to a task execution apparatus for execution by the task execution apparatus.

### TECHNICAL FIELD

Implementations of the present specification relate to the field of big data computing technologies, and specifically, to a computing task processing method and apparatus.

### BACKGROUND

In the field of artificial intelligence technologies, a neural network learning model includes several computing units, each computing unit can be abstracted into an operator, and each operator performs computing processing on input data. When graph data is input to a neural network for computing, an external data storage apparatus is usually used as a cache extension, so as to relieve memory pressure of a computing device.

### SUMMARY

Implementations of the present specification provide an operator reconstruction-based computing task processing method and apparatus. In the task processing method, at least two operators suitable for reconstruction in an operator execution logic graph of a computing task are reconstructed into a reconstruction operator, and when operator computing of the reconstruction operator is performed, the entire reconstruction operator is used as a single operator to perform data exchange with an external data storage apparatus, without a need to write an intermediate computing result of the reconstruction operator into the external data storage apparatus and read from the external data storage apparatus, thereby reducing a quantity of data read and write operations between a task execution apparatus and the external data storage apparatus, and improving task computing efficiency.

According to an aspect of the implementations of the present specification, a computing task processing method is provided, including: obtaining a first computing task, the first computing task including a first operator execution logic graph used for task computing; performing operator reconstruction on the first operator execution logic graph based on an operator dependency in the first operator execution logic graph and a data cache capacity for operator computing, to obtain a second operator execution logic graph, at least a part of operators in the second operator execution logic graph including an operator structure formed by at least two operators in the first operator execution logic graph; and providing a second computing task including the second operator execution logic graph to a task execution apparatus for execution by the task execution apparatus.

According to an aspect of the implementations of the present specification, a computing task processing apparatus is further provided, including: a task acquisition unit, configured to obtain a first computing task, the first computing task including a first operator execution logic graph used for task computing; an operator reconstruction unit, configured to perform operator reconstruction on the first operator execution logic graph based on an operator dependency in the first operator execution logic graph and a data cache capacity for operator computing, to obtain a second operator execution logic graph, at least a part of operators in the second operator execution logic graph including an operator structure formed by at least two operators in the first operator execution logic graph; and a task providing unit, configured to provide a second computing task including the second operator execution logic graph to a task execution apparatus for execution by the task execution apparatus.

According to an aspect of the implementations of the present specification, an electronic device is further provided, including: at least one processor, a memory coupled to the at least one processor, and a computer program stored in the memory. The at least one processor executes the computer program to implement any computing task processing method described above.

### BRIEF DESCRIPTION OF DRAWINGS

The essence and advantages of implementations of the present specification can be further understood with reference to the following accompanying drawings. In the accompanying drawings, similar components or features can have the same reference numeral.

FIG. 1 is a schematic diagram illustrating an example framework structure of a task processing system.

FIG. 2 is a schematic diagram illustrating an example of an operator execution logic graph.

FIG. 3 is a schematic diagram illustrating an example of a task computing device according to an implementation of the present specification.

FIG. 4 is a flowchart illustrating an example of a computing task processing method according to an implementation of the present specification.

FIG. 5 is a schematic diagram illustrating an example of a second operator execution logic graph after operator reconstruction according to an implementation of the present specification.

FIG. 6 shows an example flowchart illustrating an operator reconstruction process according to an implementation of the present specification.

FIG. 7 is a block diagram illustrating an example of a computing task processing apparatus according to an implementation of the present specification.

FIG. 8 is a block diagram illustrating an electronic device for implementing a computing task processing method according to an implementation of the present specification.

### DESCRIPTION OF IMPLEMENTATIONS

The following discusses the subject matter described herein with reference to example implementations. It should be understood that the discussion of these implementations is merely to enable a person skilled in the art to better understand and thereby achieve the subject matter described herein, and is not intended to limit the protection scope, applicability, or examples set forth in the claims. The function and arrangement of discussed elements can be changed without departing from the protection scope of the content of implementations of the present specification. In the examples, various processes or components can be omitted, replaced, or added as needed. In addition, features described with respect to some examples can alternatively or additionally be combined in other examples.

As used herein, the term “include” and a variation thereof are open-ended terms, and mean “including but not limited to”. The term “based on” represents “partially based on”. The terms “one implementation” and “an implementation” represent “at least one implementation”. The term “another implementation” represent “at least one other implementation”. The terms “first”, “second”, etc. can represent different or same objects. Other explicit or implicit definitions can be included below. Unless the context clearly indicates otherwise, the definition of a term is consistent throughout the present specification.

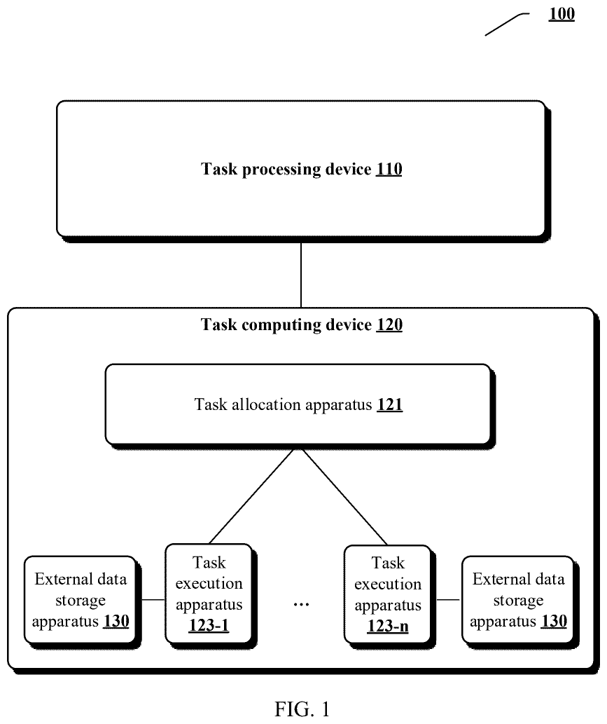

FIG. 1 is a schematic diagram illustrating an example framework structure of a task processing system 100.

As shown in FIG. 1, the task processing system 100 includes a task processing device 110 and a task computing device 120. The task processing device 110 is configured to process a task, such as a model processing task of a machine learning model, a graph learning inference task, etc. In a processing process of a task, when task computing needs to be performed, the task processing device 110 can invoke the task computing device 120 to implement task computing. Specifically, the task processing device 110 can provide a to-be-computed computing task to the task computing device 120, so the task computing device 120 performs computing processing according to the computing task. In some implementations, the task processing device can include, for example, a task processing device or a task processing node based on a CPU, and the task computing device can include, for example, a task computing device or a task computing node based on a GPU or another computing chip.

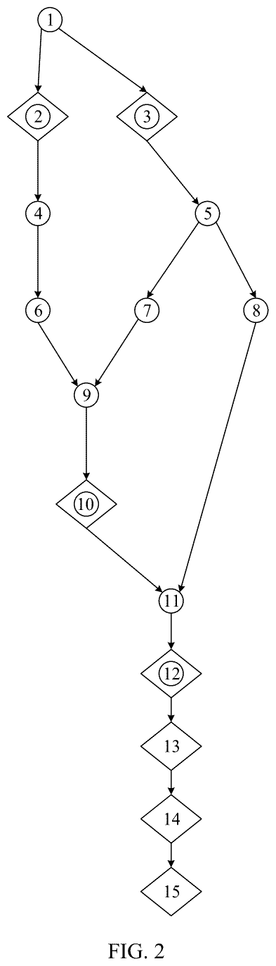

In some examples, as shown in FIG. 1, the task computing device 120 can include a task allocation apparatus 121 and multiple task execution apparatuses 123-1 to 123-n. The task allocation apparatus 121 is configured to receive a computing task from the task processing device. The received computing task can include an operator task set formed by multiple operator tasks and data source information of data for operator computing of the operator task. The operator task set can be represented as an operator execution logic graph formed by multiple operators according to an operator dependency. FIG. 2 is a schematic diagram illustrating an example of an operator execution logic graph. As shown in FIG. 2, each number represents a corresponding operator, and a connection between operators represents an operator dependency.

After receiving the computing task, the task allocation apparatus 121 splits the received computing task into multiple sub-computing tasks, where each sub-computing task includes a corresponding sub-operator execution logic graph and data source information of data for operator computing of the sub-computing task. In some implementations, splitting the computing task can include splitting the computing task based on data source splitting. In this case, the sub-operator execution logic graph corresponding to each sub-computing task can be the same as the operator execution logic graph corresponding to the computing task, and the splitting is for a data source used by the sub-computing task.

In some implementations, splitting the computing task can include splitting the computing task based on splitting of the operator execution logic graph, for example, splitting the operator execution logic graph into multiple sub-execution logic graph structures, where each sub-execution logic graph structure is used as a sub-operator execution logic in the sub-computing task. In this case, the sub-operator execution logic graph corresponding to each sub-computing task can be different from the operator execution logic graph corresponding to the computing task, and each sub-operator execution logic graph includes a sub-graph structure of the operator execution logic graph.

In addition, in some examples, the data source used by the computing task can be further split, and therefore, a data source used by each sub-computing task is also different. Then, each sub-task is provided to a corresponding task execution apparatus to perform task computing. The task execution apparatus then provides an obtained task computing result to the task allocation apparatus, and the task allocation apparatus performs integration and returns the result to the task processing device. Or the task execution apparatus then provides the obtained task computing result to the task processing device, and the task processing device integrates the task computing result for subsequent use.

In some examples, the task computing device can include a task execution apparatus. In this case, the task execution apparatus receives a computing task from the task processing device and processes the received computing task. After a computing result is obtained, the task execution apparatus returns the computing result to the task processing device.

Each task execution apparatus 123 can be connected to one external data storage apparatus 130. During task computing, the task execution apparatus 123 executes each operator task according to an operator execution logic sequence reflected by an operator dependency. For each operator task, the task execution apparatus 123 obtains input data of the operator from the external data storage apparatus 130, then uses the input data to perform operator computing to obtain a computing result, and writes the obtained computing result into the external data storage apparatus 130. That is, for each operator, the task execution apparatus 123 performs one IO read/write operation with the external data storage apparatus 130.

The framework structure shown in FIG. 1 can be applied to an application scenario of graph learning. The task processing system is configured to execute a graph learning inference task based on graph data, and when graph computing processing is encountered, generate a graph computing task, and provide the graph computing task to a task computing system (or “graph computing system”). The task computing system executes the graph computing task and returns a graph computing processing result.

According to the above task computing manner, each operator computing task execution apparatus 123 performs one IO read/write operation with the external data storage apparatus 130, and the IO read/write operation generates an IO read/write delay, thereby reducing task computing efficiency.

In view of the above, an implementation of the present specification provides a task computing processing solution based on operator reconstruction. In the task computing processing solution, at least two operators suitable for reconstruction in an operator execution logic graph of a computing task are reconstructed into a reconstruction operator, and when operator computing of the reconstruction operator is performed, the entire reconstruction operator is used as a single operator to perform data exchange with an external data storage apparatus, without a need to write an intermediate computing result of the reconstruction operator into the external data storage apparatus and read from the external data storage apparatus, thereby reducing a quantity of data read and write operations between a task execution apparatus and the external data storage apparatus, and improving task computing efficiency.

The following describes a computing task processing method and apparatus according to an implementation of the present specification with reference to the accompanying drawings.

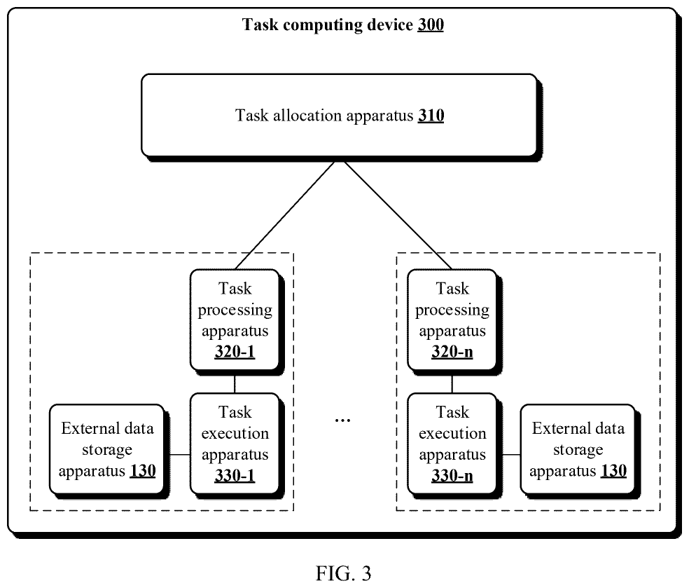

FIG. 3 is a schematic diagram illustrating an example of a task computing device 300 according to an implementation of the present specification.

As shown in FIG. 3, the task computing device 300 includes a task allocation apparatus 310, multiple task processing apparatuses 320-1 to 320-n, and multiple task execution apparatuses 330-1 to 330-n. The task allocation apparatus 310 can be deployed at a task allocation node, and the task processing apparatus 320 and the task execution apparatus 330 can be deployed at a distributed computing node. Each distributed computing node includes one task execution apparatus and one task processing apparatus.

The task allocation apparatus 310 is configured to: receive a computing task from the task processing device, and split the received computing task into multiple sub-computing tasks, where each sub-computing task includes a first operator execution logic graph and data source information of data for operator computing. Then, the task allocation apparatus 310 distributes the sub-computing tasks to a corresponding computing node. After receiving the sub-computing task, the task processing apparatus 320 in the computing node performs operator reconstruction on the first operator execution logic graph in the sub-computing task to reconstruct a second operator execution logic graph, where at least a part of operators in the second operator execution logic graph includes an operator structure formed by at least two operators in the first operator execution logic graph. Then, the task execution apparatus 330 uses corresponding data to perform corresponding sub-computing task computing according to the second operator execution logic graph.

In some implementations, the task processing apparatus 320 can alternatively or additionally be deployed at a task allocation node, and is configured to: perform operator reconstruction on the sub-computing tasks split by the task allocation apparatus 310, and then provide the sub-computing tasks to each task execution apparatus 330.

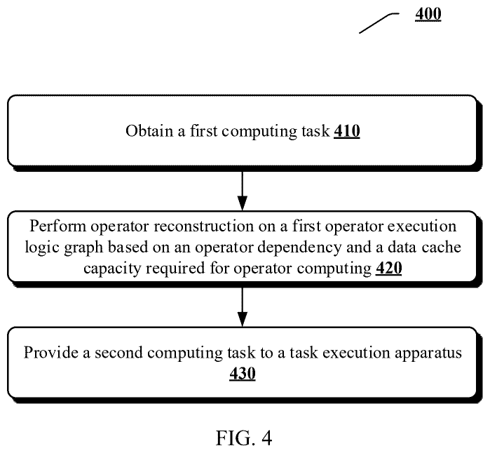

FIG. 4 is a flowchart illustrating an example 400 of a computing task processing method according to an implementation of the present specification. The computing task processing method is performed by a task processing apparatus.

As shown in FIG. 4, at 410, obtain a first computing task.

In some examples, the first computing task can include multiple first computing tasks obtained after processing by a task allocation apparatus. In some examples, the first computing task can include a single first computing task provided by the task allocation apparatus to a computing node. The first computing task can include a first operator execution logic graph used for task computing. The first operator execution logic graph can be constructed based on a computing logic of a to-be-processed computing task. For example, in a case in which the to-be-processed computing task is a machine learning task, an operator execution logic graph corresponding to the computing task can be constructed based on a computing logic of a machine learning model. The first operator execution logic graph can include an operator execution logic topology graph constructed by multiple operators (OP) according to an operator dependency between the operators. In the present specification, the term “operator” can correspond to a computing logic unit in a computing task, such as a computing logic in a hierarchy in a machine learning model, such as a weight summation process in a fully connected layer (FC layer), such as an activation function like tanh and ReLUctant.

The relevancy among operations, e.g., operator dependency, can be used to represent a logic relevancy, e.g., logic dependency, among operators. In the description herein, operator dependency is used as an example of relevancy among operations, and logic dependency is used as an example of relevancy in logic among operators, for descriptive and/or illustrative purposes, which does not limit the scope of the disclosure. The relevancy among operators may include other relationships among operations, which are also included in the scope of the disclosure. In an example, the operator dependency can be embodied by a data dependency. For example, an output of one operator can be used as an input to another operator. The operator dependency between operators can reflect a logic execution sequence of the operators.

For example, the operator execution logic graph shown in FIG. 2 is used as the first operator execution logic graph. The first operator execution logic graph corresponds to a deep learning model used for graph data computing. Graph data includes edge data and point data, and an operator type includes an edge operator, a point operator, and a point-edge operator.

As shown in FIG. 2, edge data is input to an edge operator 1, and the edge operator 1 performs a value assignment operation on the input edge data, and then outputs corresponding edge data. The edge data output by the edge operator 1 is separately input to a point-edge operator 2 and a point-edge operator 3. In addition, inputs of the point-edge operator 2 and the point-edge operator 3 further include point data. The point-edge operator 2 and the point-edge operator 3 perform representation processing on the edge data and the point data, and output a feature vector represented as edge data.

Then, the edge data from the point-edge operators 2 and 3 is separately input to edge operators 4 and 5. In addition, the input to the edge operator 5 can further include original edge data. The edge operators 4 and 5 are configured to perform vector concatenation on feature vectors of the input edge data, and output a concatenated feature vector of the edge data.

Edge operators 6, 7, and 8 can be operators of a linear layer, and can compute input edge data through matrix multiplication. The edge operator 6 can output edge data representing Q, the edge operator 7 can output edge data representing K, and the edge operator 8 can output edge data representing V.

The input to the edge operator 9 can include outputs of the edge operators 6 and 7, and two inputs can be correspondingly multiplied and then summed. For example, Q output by the edge operator 6 and K output by the edge operator 7 can be correspondingly multiplied and summed, and an obtained result still represents edge data.

A point-edge operator 10 can be a Softmax layer, and an input thereto includes edge data output by the edge operator 9. The point-edge operator 10 can perform aggregation computing on input edge data, and obtained aggregated data can be used as a part of point data of a corresponding represented point. The represented point can be a point connected to each edge. Then, computing is performed based on the aggregated data and original point data, and a computing result is allocated to corresponding edges as edge data. Therefore, the point-edge operator 10 outputs edge data. In an example, the edge data output by the point-edge operator 10 can represent a weight of each edge.

Using an origin as an example, edge data of each edge connected to the origin can be subjected to aggregation computing, and an obtained aggregation result can be used as a part of point data of the origin. Then, the point data of the origin can be subjected to aggregation computing with the aggregation result as updated point data of the origin. Then, the point data is averaged to each edge according to a quantity of edges connected to the origin, and an obtained result can be used as edge data of each edge.

An input to an edge operator 11 includes edge data from the point-edge operator 10 and edge data from the edge operator 8, and corresponding multiplication computing is performed on the input edge data to obtain corresponding edge data. In an example, a weight from the point-edge operator 10 is correspondingly multiplied by a V value from the edge operator 8 to obtain an updated V value, and each V value can represent edge data on a corresponding edge.

Edge data corresponding to each edge is input to a point-edge operator 12, and then aggregation computing is performed on the edge data of each edge, so obtained aggregated data can be used as point data of a corresponding represented point. Then, the point data is output.

Point operators 13, 14, and 15 separately perform computing processing on the point data. In an example, the point operators 13, 14, and 15 can represent a feature concatenation layer, a fully connected layer, and an activation function layer, respectively.

In an example, the first computing task can further include data source information of data required by an operator. For example, the data source information can be used to indicate data storage index information of a storage location of data in a data storage device. In some implementations, data can be stored at different data storage devices. Correspondingly, the data source information can further store device index information, which is used to index a data storage device at which data is stored.

Returning to FIG. 4, at 420, perform operator reconstruction on the first operator execution logic graph based on an operator dependency in the first operator execution logic graph and a data cache capacity for operator computing, to obtain a second operator execution logic graph.

In the present specification, the term “operator reconstruction” is used to refer to combining at least two operators that meet a condition (that is, the operator dependency and the data cache capacity for operator computing) in the first operator execution logic graph to form a reconstructible operator structure, and the reconstructible operator structure can be used as a single operator to perform data exchange processing with the outside when operator computing is performed. Specifically, in the reconstructible operator structure, an input end of an operator that needs to obtain input data from an external device of the reconstructible operator structure is used as an input end of the reconstructible operator structure, and computing result data needs to be written into an output end of an external data storage device of the reconstructible operator structure as an output end of the reconstructible operator structure. An operator at an input end with a reconstructible operator structure can also be referred to as an input operator with a reconstructible operator structure, an operator at an output end with a reconstructible operator structure can also be referred to as an output operator with a reconstructible operator structure, and another operator in the reconstructible operator structure can be referred to as an intermediate operator. During operator computing, only an operator computing result of an output operator is written into an external data storage device, and an operator computing result of another operator different from the output operator is cached in the task execution apparatus.

In some implementations, an operator structure can be segmented from the first operator execution logic graph according to the operator dependency, and there is an operator dependency between operators in the segmented operator structure. Then, a data cache capacity required by operator computing of an operator structure is determined, and whether the operator structure is a reconstructible operator structure is determined according to the determined data cache capacity for operator computing and an operator cache capacity threshold. For example, if the determined data cache capacity for operator computing is not greater than the operator cache capacity threshold, it is determined that the operator structure is a reconstructible operator structure. If the determined data cache capacity for operator computing is greater than the operator cache capacity threshold, it is determined that the operator structure is not a reconstructible operator structure. In this case, some operators need to be removed from the operator structure until the determined data cache capacity for operator computing of the operator structure is greater than the operator cache capacity threshold.

In some examples, if the determined data cache capacity for operator computing is less than the operator cache capacity threshold, an operator can be added to the currently segmented operator structure according to the operator dependency. Then, it is determined whether an operator structure obtained after an operator is added can be used as a reconstructible operator structure. If the operator structure obtained after an operator is added cannot be used as a reconstructible operator structure, the previously determined operator structure is determined as a reconstructible operator structure. If the operator structure obtained after an operator is added can be used as a reconstructible operator structure, the above process is cyclically executed until the operator structure obtained after an operator is added cannot be used as a reconstructible operator structure.

In the present specification, the term “data cache capacity for operator computing” can be used interchangeably with the term “data cache capacity for operator computing of an operator structure”, and is used to indicate a cache capacity or a cache capability for operator structure to perform operator computing. When the entire operator structure is computed as a single operator, data that is related to operator computing and that does not need to be output to an external data storage device needs to be cached, for example, input data for operator computing, an obtained intermediate operator computing result, and an operator parameter for operator computing. Therefore, the task execution apparatus (that is, a computing device) needs to provide a corresponding cache capability. Because operator computing of different operators needs different data and operator logics, data cache capacity requirements are also different.

In a reconstructible operator structure, an operator computing result of an output operator needs to be written into an external data storage device. Therefore, when a reconstructible operator structure is being determined, for a data cache capacity for operator computing of the operator structure, the operator computing result of the output operator of the operator structure can be not considered. In an example, the data cache capacity for operator computing of the operator structure can be determined according to a resultant data amount of an operator computing result of another operator in the operator structure except the output operator. In an example, a resultant data amount of each operator computing result can be determined according to a data amount of data for operator computing and a computing logic of the operator.

In some implementations, the data cache capacity for operator computing of the operator structure can be determined according to a resultant data amount of an operator computing result of another operator in the operator structure except the output operator and a resultant data type of an operator computing result. The resultant data type of the operator computing result can vary with an operator type. For example, the resultant data type of the operator computing result includes a weight presented as a value and matrix vectors of different dimensions. FIG. 2 is used as an example. An operator computing result output by the operator 4 is a matrix vector of a 200×300 dimension, and an operator computing result output by the operator 10 is a weight.

The data amount of the data required by the operator can be queried from a corresponding data source based on data source information of the data required by the operator. The resultant data amount of the operator computing result is proportional to the data amount of the data required by the operator. That is, a larger data amount of the data required by the operator indicates a larger resultant data amount of the operator computing result. For example, a resultant data amount of an operator computing result in a case of unit input data can be determined based on a computing logic of an operator as a unit resultant data amount, and then the resultant data amount of the operator computing result is determined according to the unit resultant data amount and the data amount of the data required by the operator.

In some implementations, in addition to caching the operator computing result of the operator, input data of the operator needs to be cached during operator computing. In this case, the data cache capacity for operator computing of the operator structure can be determined according to the resultant data amount of operator computing of another operator in the operator structure except the output operator and the data amount of external input data of all operators in the operator structure.

For example, a sum of resultant data amounts of operator computing of other operators in the operator structure except the output operator and a sum of data amounts of external input data of all the operators in the operator structure can be determined. Then, the sum of the resultant data amounts is added to the sum of the data amounts of the external input data, as the data cache capacity for operator computing of the operator structure.

In some implementations, in addition to caching the operator computing result of the operator, a corresponding operator parameter needs to be cached during operator computing. In this case, the data cache capacity for operator computing of the operator structure can be determined according to the resultant data amount of operator computing of another operator in the operator structure except the output operator and parameter data amounts of operator parameters of all operators in the operator structure.

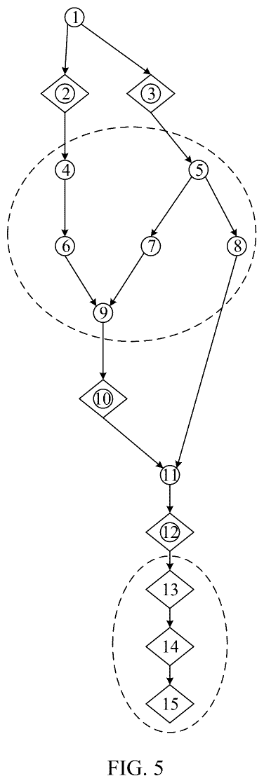

FIG. 5 is a schematic diagram illustrating an example of a second operator execution logic graph after operator reconstruction according to an implementation of the present specification. As shown in FIG. 5, the second operator execution logic graph is obtained by performing operator reconstruction based on the first operator execution logic graph shown in FIG. 2. Edge operators 4, 5, 6, 7, 8, and 9 become one reconstructible operator structure through operator reconstruction, and point operators 13, 14, and 15 become one reconstructible operator structure through operator reconstruction.

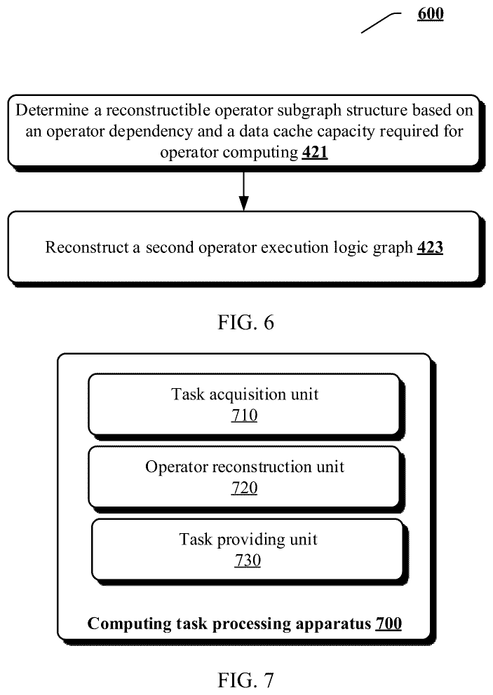

FIG. 6 shows an example flowchart illustrating an operator reconstruction process 600 according to an implementation of the present specification.

As shown in FIG. 6, at 421, determine at least one reconstructible operator structure from a first operator execution logic graph based on an operator dependency in the first operator execution logic graph and a data cache capacity for operator computing.

In an example, at least one reconstructible operator structure can be determined from the first operator execution logic graph based on the operator dependency in the operator structure and whether the data cache capacity for operator computing of the operator structure meets an operator computing cache capacity threshold limit.

In some implementations, when the task execution apparatus performs task computing, multiple threads can be executed in parallel, and each thread executes operator computing of one operator. In this case, the operator computing cache capacity threshold can be determined according to a cache capacity of the task execution apparatus and thread parallelism. For example, the cache capacity of the task execution apparatus is divided by the thread parallelism to obtain an operator cache capacity threshold of the task execution apparatus.

In some implementations, a part of the cache capacity value obtained by dividing the cache capacity of the task execution apparatus by the thread parallelism can be used as the operator cache capacity threshold, and the remaining cache capacity can be reserved to store other data of the operator, for example, the operator parameter of the operator. For example, the cache capacity value obtained by dividing the cache capacity of the task execution apparatus by the thread parallelism can subtract a predetermined cache capacity value to obtain the operator cache capacity threshold of the task execution apparatus. Or the cache capacity value obtained by dividing the cache capacity of the task execution apparatus by the thread parallelism is divided by a predetermined value greater than 1 to obtain the operator cache capacity threshold of the task execution apparatus.

In some implementations, for determining of the reconstructible operator structure, at least one reconstructible operator structure from the first operator execution logic graph can be determined, in a manner of traversing the first operator execution logic graph, based on the operator dependency in the first operator execution logic graph and the data cache capacity for operator computing.

During each time of traversal, a reconstructible operator structure is determined from the remaining operator execution logic graph in which reconstructible operator structure reconstruction processing is not currently performed, until a reconstructible operator structure determining process is completed for all operators of the first operator execution logic graph.

In some implementations, when a current operator to be traversed currently is determined, an operator closest to an input operator in operators that are not traversed can be determined as the current operator, and the input operator is an operator to which source data is input. When at least two operators have the same distance from the input operator, one operator can be selected from the at least two operators as the current operator.

In some implementations, operator reconstruction can be performed on the first operator execution logic graph based on the operator dependency in the first operator execution logic graph, the data cache capacity for operator computing, and an operator type, to obtain the second operator execution logic graph. In this case, in a case in which the data cache capacity for operator computing of the operator structure formed by operators of the same operator type according to the operator dependency is not greater than the operator cache capacity threshold, the operator structure is reconstructed into a reconstructible operator structure.

At 423, use, as a whole, the determined at least one reconstructible operator structure as one operator in the second operator execution logic graph, and use each remaining operator in the first operator execution logic graph as one operator in the second operator execution logic graph, to reconstruct the second operator execution logic graph.

Back to FIG. 4, at 430, a second computing task can be provided to a task execution apparatus for execution by the task execution apparatus.

In some implementations of the present specification, the second computing task includes the second operator execution logic graph, and the task execution apparatus performs computing processing according to the second operator execution logic graph.

In the second operator execution logic graph, when operator computing is performed, each reconstructible operator structure and the remaining operator are used as a single operator to interact with an external data storage device. For example, for each reconstructible operator structure, only an operator computing result of an output operator is written into an external data storage apparatus, and an operator computing result of another operator is cached in an internal cache of the task execution apparatus. According to the above processing manner, a data read/write operation frequency between the task execution apparatus and the external data storage apparatus can be reduced, so computing efficiency of task computing at the task execution apparatus is improved.

In an example, the second computing task can further include data source information of data required by an operator after operator reconstruction. When receiving the second computing task, the task execution apparatus can obtain, according to the data source information in the second computing task, data for operator computing, and perform computing processing according to the obtained data and the second operator execution logic graph.

FIG. 7 is a block diagram illustrating an example of a computing task processing apparatus 700 according to an implementation of the present specification.

As shown in FIG. 7, the computing task processing apparatus 700 includes a task acquisition unit 710, an operator reconstruction unit 720, and a task providing unit 730.

The task acquisition unit 710 can be configured to obtain a first computing task, the first computing task including a first operator execution logic graph used for task computing; the operator reconstruction unit 720 can be configured to perform operator reconstruction on the first operator execution logic graph based on an operator dependency in the first operator execution logic graph and a data cache capacity for operator computing, to obtain a second operator execution logic graph, at least a part of operators in the second operator execution logic graph including an operator structure formed by at least two operators in the first operator execution logic graph; and the task providing unit 730 can be configured to provide a second computing task including the second operator execution logic graph to a task execution apparatus for execution by the task execution apparatus.

In an example, the operator reconstruction unit 720 can include a subgraph structure determining module and a graph reconstruction module. The subgraph structure determining module can be configured to determine at least one reconstructible operator structure from the first operator execution logic graph based on the operator dependency in the first operator execution logic graph and the data cache capacity for operator computing; and the graph reconstruction module can be configured to: use, as a whole, the determined at least one reconstructible operator structure as one operator in the second operator execution logic graph, and use each remaining operator in the first operator execution logic graph as one operator in the second operator execution logic graph, to reconstruct the second operator execution logic graph.

In an example, the subgraph structure determining module is configured to: determine, in a manner of traversing the first operator execution logic graph, at least one reconstructible operator structure from the first operator execution logic graph based on the operator dependency in the first operator execution logic graph and the data cache capacity for operator computing.

In an example, the operator reconstruction unit 720 can be configured to perform operator reconstruction on the first operator execution logic graph based on the operator dependency in the first operator execution logic graph, the data cache capacity for operator computing, and an operator type, to obtain the second operator execution logic graph.

The above describes the implementations of the task processing method and apparatus according to the implementations of the present specification with reference to FIG. 1 to FIG. 7.

The task processing apparatus in the implementations of the present specification can be implemented by using hardware, or can be implemented by using software or a combination of hardware and software. Taking software implementation as an example, a logical apparatus is implemented by reading, by using a processor of a device where the apparatus is located, corresponding computer program instructions in a memory into an internal memory and running the computer program instructions. In the implementations of the present specification, for example, the task processing apparatus can be implemented by using an electronic device.

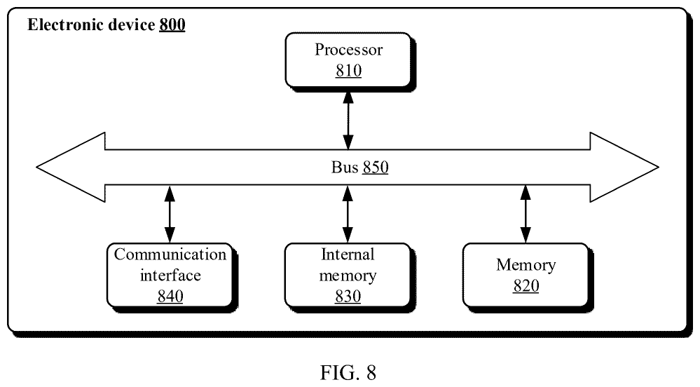

FIG. 8 is a block diagram illustrating an electronic device 800 for implementing a computing task processing method according to an implementation of the present specification.

As shown in FIG. 8, the electronic device 800 can include at least one processor 810, a memory (for example, a non-volatile memory) 820, an internal memory 830, and a communication interface 840, and the at least one processor 810, the memory 820, the internal memory 830, and the communication interface 840 are connected together through a bus 850. The at least one processor 810 executes at least one computer-readable instruction (for example, the above element implemented in a form of software) stored or encoded in the memory.

In an implementation, the memory stores computer executable instructions that, when executed, cause the at least one processor 810 to: obtain a first computing task, the first computing task including a first operator execution logic graph used for task computing; perform operator reconstruction on the first operator execution logic graph based on an operator dependency in the first operator execution logic graph and a data cache capacity for operator computing, to obtain a second operator execution logic graph, at least a part of operators in the second operator execution logic graph including an operator structure formed by at least two operators in the first operator execution logic graph; and provide a second computing task including the second operator execution logic graph to a task execution apparatus for execution by the task execution apparatus.

It should be understood that when the computer-executable instructions stored in the memory are executed, the at least one processor 810 is enabled to perform the various operations and functions described above with reference to FIG. 1 to FIG. 7 in implementations of the present specification.

According to an implementation, a program product such as a machine-readable medium is provided. The machine-readable medium can have instructions (for example, the elements implemented in a form of software), and when the instructions are executed by a machine, the machine is enabled to perform the various operations and functions described above with reference to FIG. 1 to FIG. 7 in implementations of the present specification.

Specifically, a system or an apparatus provided with a readable storage medium can be provided. Software program code implementing the functions in any one of the above implementations is stored in the readable storage medium, and a computer or a processor of the system or the apparatus is enabled to read and execute instructions stored in the readable storage medium.

In this case, the program code read from the readable medium can implement the functions of any one of the above implementations, and therefore, the machine-readable code and the readable storage medium storing the machine-readable code constitute a part of the present disclosure.

Computer program code needed for the various operations of the present specification can be written in any one or more programming languages, including object-oriented programming languages such as Java, Scala, Smalltalk, Eiffel, JADE, Emerald, C++, C #, VB, NET, and Python, conventional programming languages such as C, Visual Basic 2003, Perl, COBOL 2002, PHP, and ABAP, dynamic programming languages such as Python, Ruby, and Groovy, or other programming languages. The program code can run on a user computer, or as an independent software package on a user computer, or partially on a user computer and partially on a remote computer, or completely on a remote computer or server. In the latter case, the remote computer can be connected to a user computer in any network form, for example, a local area network (LAN) or a wide area network (WAN), or connected to an external computer (for example, through the Internet), or in a cloud computing environment, or used as a service, for example, a software as a service (SaaS).

Examples of the readable storage medium include a floppy disk, a hard disk, a magneto-optical disk, an optical disk (for example, a CD-ROM, CD-R, CD-RW, a DVD-ROM, a DVD-RAM, or DVD-RW), a magnetic tape, a non-volatile memory card, and a ROM. In some examples, the program code can be downloaded from a server computer or from the cloud by using a communication network.

Specific implementations of the present specification are described above. Other implementations fall within the scope of the appended claims. In some situations, the actions or steps described in the claims can be performed in an order different from the order in the implementation and the desired results can still be achieved. In addition, the process depicted in the accompanying drawings does not necessarily require a particular execution order to achieve the desired results. In some implementations, multi-tasking and parallel processing can be advantageous.

Not all the steps and units in the above processes and system structural diagrams are mandatory, and some steps or units can be ignored as actually needed. An execution sequence of the steps is not fixed, and can be determined as needed. The apparatus structures described in the above implementations can be physical structures or logical structures. For example, some units can be implemented by the same physical entity, or some units can be respectively implemented by a plurality of physical entities, or can be jointly implemented by some components in a plurality of independent devices.

The term “example” used throughout the present specification means “being used as an example, an instance, or an illustration”, and does not mean “being more preferred” or “being more advantageous” than other implementations. Specific implementations include specific details for the purpose of providing an understanding of the described technologies. However, these technologies can be practiced without these details. In some instances, well-known structures and apparatuses are shown in a form of block diagrams to avoid obscuring the concepts of the described implementations.

Example implementations of the present specification are described in detail above with reference to the accompanying drawings. However, implementations of the present specification are not limited to specific details of the above implementations. Various simple variations of the technical solutions of implementations of the present specification can be made within the scope of the technical concept of implementations of the present specification, and fall within the protection scope of implementations of the present specification.

The above descriptions of the content of the present specification are provided to enable any person of ordinary skill in the art to implement or use the content of the present specification. Various modifications to the content of the present specification are clear to a person of ordinary skill in the art, and the general principles defined herein can be applied to other variations without departing from the protection scope of the content of the present specification. Therefore, the content of the present specification is not limited to the examples and designs described herein, but is consistent with the widest scope in accordance with the principles and novel features disclosed herein.

What is claimed is:

1. A computing task processing method, comprising:
obtaining a first computing task, the first computing task including a first operator execution logic graph used for task computing;
performing operator reconstruction on the first operator execution logic graph based on an operator dependency in the first operator execution logic graph and a data cache capacity for operator computing, to obtain a second operator execution logic graph, at least one of operators in the second operator execution logic graph including an operator structure formed by at least two operators in the first operator execution logic graph; and
providing a second computing task including the second operator execution logic graph to a task execution apparatus for execution by the task execution apparatus.

2. The computing task processing method according to claim 1, wherein the performing operator reconstruction on the first operator execution logic graph based on the operator dependency in the first operator execution logic graph and the data cache capacity for operator computing includes:
determining at least one reconstructible operator structure from the first operator execution logic graph based on the operator dependency in the first operator execution logic graph and the data cache capacity for operator computing; and
using, as a whole, the determined at least one reconstructible operator structure as one operator in the second operator execution logic graph, and using each remaining operator in the first operator execution logic graph as one operator in the second operator execution logic graph, to reconstruct the second operator execution logic graph.

3. The computing task processing method according to claim 2, wherein the data cache capacity for operator computing is determined based on a resultant data amount of operator computing of a first operator different from a second operator used as an output operator in an operator structure.

4. The computing task processing method according to claim 2, wherein the data cache capacity for operator computing is determined based on a resultant data amount of operator computing of a first operator different from a second operator used as an output operator in an operator structure and a data amount of external input data of all operators in the operator structure.

5. The computing task processing method according to claim 2, wherein the determining at least one reconstructible operator structure from the first operator execution logic graph based on the operator dependency in the first operator execution logic graph and the data cache capacity for operator computing includes:
determining, in a manner of traversing the first operator execution logic graph, at least one reconstructible operator structure from the first operator execution logic graph based on the operator dependency in the first operator execution logic graph and the data cache capacity for operator computing.

6. The computing task processing method according to claim 1, wherein the performing operator reconstruction on the first operator execution logic graph based on the operator dependency in the first operator execution logic graph and the data cache capacity for operator computing, to obtain the second operator execution logic graph includes:
performing operator reconstruction on the first operator execution logic graph based on the operator dependency in the first operator execution logic graph, the data cache capacity for operator computing, and an operator type, to obtain the second operator execution logic graph.

7. The computing task processing method according to claim 1, wherein the first computing task further includes data source information of data required by an operator, and the second computing task further includes data source information of data required by an operator after operator reconstruction.

8. The computing task processing method according to claim 1, wherein the first computing task includes a computing task based on a machine learning model.

9. A computing task processing apparatus, comprising:
a task acquisition unit, configured to obtain a first computing task, the first computing task including a first operator execution logic graph used for task computing;
an operator reconstruction unit, configured to perform operator reconstruction on the first operator execution logic graph based on an operator dependency in the first operator execution logic graph and a data cache capacity for operator computing, to obtain a second operator execution logic graph, at least one of operators in the second operator execution logic graph including an operator structure formed by at least two operators in the first operator execution logic graph; and
a task providing unit, configured to provide a second computing task including the second operator execution logic graph to a task execution apparatus for execution by the task execution apparatus.

10. The computing task processing apparatus according to claim 9, wherein the operator reconstruction unit includes:
a subgraph structure determining module, configured to determine at least one reconstructible operator structure from the first operator execution logic graph based on the operator dependency in the first operator execution logic graph and the data cache capacity for operator computing; and
a graph reconstruction module, configured to: use, as a whole, the determined at least one reconstructible operator structure as one operator in the second operator execution logic graph, and use each remaining operator in the first operator execution logic graph as one operator in the second operator execution logic graph, to reconstruct the second operator execution logic graph.

11. The computing task processing apparatus according to claim 10, wherein the subgraph structure determining module is configured to:
determine, in a manner of traversing the first operator execution logic graph, at least one reconstructible operator structure from the first operator execution logic graph based on the operator dependency in the first operator execution logic graph and the data cache capacity for operator computing.

12. The computing task processing apparatus according to claim 10, wherein the operator reconstruction unit is configured to:
perform operator reconstruction on the first operator execution logic graph based on the operator dependency in the first operator execution logic graph, the data cache capacity for operator computing, and an operator type, to obtain the second operator execution logic graph.

13. An electronic device, comprising at least one processor, at least one storage device coupled to the at least one processor, and computer executable instructions stored in the at least one storage device, the computer executable instructions, when executed by the at least one processor, enable the at least one processor to, individually or collectively, implement acts including:
obtaining a first computing task, the first computing task including a first operator execution logic graph used for task computing;
performing operator reconstruction on the first operator execution logic graph based on an operator dependency in the first operator execution logic graph and a data cache capacity for operator computing, to obtain a second operator execution logic graph, at least one of operators in the second operator execution logic graph including an operator structure formed by at least two operators in the first operator execution logic graph; and
providing a second computing task including the second operator execution logic graph to a task execution apparatus for execution by the task execution apparatus.

14. The electronic device according to claim 13, wherein the performing operator reconstruction on the first operator execution logic graph based on the operator dependency in the first operator execution logic graph and the data cache capacity for operator computing includes:
determining at least one reconstructible operator structure from the first operator execution logic graph based on the operator dependency in the first operator execution logic graph and the data cache capacity for operator computing; and
using, as a whole, the determined at least one reconstructible operator structure as one operator in the second operator execution logic graph, and using each remaining operator in the first operator execution logic graph as one operator in the second operator execution logic graph, to reconstruct the second operator execution logic graph.

15. The electronic device according to claim 14, wherein the data cache capacity for operator computing is determined based on a resultant data amount of operator computing of a first operator different from a second operator used as an output operator in an operator structure.

16. The electronic device according to claim 14, wherein the data cache capacity for operator computing is determined based on a resultant data amount of operator computing of a first operator different from a second operator used as an output operator in an operator structure and a data amount of external input data of all operators in the operator structure.

17. The electronic device according to claim 14, wherein the determining at least one reconstructible operator structure from the first operator execution logic graph based on the operator dependency in the first operator execution logic graph and the data cache capacity for operator computing includes:
determining, in a manner of traversing the first operator execution logic graph, at least one reconstructible operator structure from the first operator execution logic graph based on the operator dependency in the first operator execution logic graph and the data cache capacity for operator computing.

18. The electronic device according to claim 13, wherein the performing operator reconstruction on the first operator execution logic graph based on the operator dependency in the first operator execution logic graph and the data cache capacity for operator computing, to obtain the second operator execution logic graph includes:
performing operator reconstruction on the first operator execution logic graph based on the operator dependency in the first operator execution logic graph, the data cache capacity for operator computing, and an operator type, to obtain the second operator execution logic graph.

19. The electronic device according to claim 13, wherein the first computing task further includes data source information of data required by an operator, and the second computing task further includes data source information of data required by an operator after operator reconstruction.

20. The electronic device according to claim 13, wherein the first computing task includes a computing task based on a machine learning model.
